(19) United States
(12) Patent Application Publication
(10) Pub. No.: US 2026/0101913 A1
(43) Pub. Date: Apr. 16, 2026

(54) EGG EXTENDER COMPOSITION

(71) Applicant: SOCIETE DES PRODUITS NESTLE S.A., Vevey (CH)

(72) Inventors: FANNY LAZZARO, Lausanne (CH); RODRIGO JOAO DA CRUZ PARRACHO, Palezieux (CH); MATHIEU JULIEN DESTRIBATS, Lutry (CH); VIONA BERNARDI, Erlenbach (CH)

(21) Appl. No.: 18/852,580

(22) PCT Filed: Mar. 30, 2023
(86) PCT No.: PCT/EP2023/058353

§ 371 Date: Sep. 30, 2024

(30) Foreign Application Priority Data
Mar. 31, 2022 (EP) 22166130.9
Jun. 9, 2022 (EP) 22178029.9

(51) Int. Cl. A23L 15/00; A21D 2/26; A23L 33/16; A23L 33/185

(52) U.S. Cl. CPC A23L 15/35; A21D 2/266; A23L 33/16; A23L 33/185

(57) ABSTRACT

The present invention relates to an egg analogue product, said product comprising a plant protein source and a basic salt, wherein the salt has a pKa in water above 7 and an equilibrium solubility in water above 0.1 g per 100 g at 25° C. at pH 7. A food product comprising the egg analogue product according to any preceding claim, wherein said food product further comprises chicken egg is also provided.

### INTRODUCTION

Demand for plant-based products has grown significantly in recent years across many food categories and applications. This trend has been driven by many factors including allergenicity, sustainability, animal welfare, and consumer shifts towards more “flexitarian” diets.

Plant based alternatives to eggs which can be used as whole or partial egg replacement in a cooked in pan egg application, in batter, in sauces, or in baked products do currently exist. However, many commercial products on the market do not sufficiently meet the needs of the consumer because they do not fully replicate conventional eggs in terms of hardness, fracturability, and other important properties.

There is a growing demand for products, particularly affordable products, that are suitable for use as extenders for conventional chicken egg.

### SUMMARY OF INVENTION

The invention relates to an egg analogue product, said product comprising a plant protein source and a basic salt.

The invention further relates to an egg analogue product, said product comprising a plant protein source and a basic salt, wherein the salt has a pKa in water above 7.

The invention further relates to an egg analogue product, said product comprising a plant protein source and a basic salt, wherein the salt has a pKa in water above 7 and an equilibrium solubility in water above 0.1 g per 100 g at 25° C. at pH 7.

In some embodiments, the plant protein source is derived from soybean.

In some embodiments, the plant protein source is derived from canola.

In some embodiments, the plant protein source is derived from chickpea.

In some embodiments, the plant protein source is soybean protein and canola protein. The soybean protein and canola protein may be present in the product in a ratio of about 1:1.

The plant protein source may be in the form of a plant protein concentrate.

In some embodiments, the egg analogue product comprises between 6 to 12 wt % plant protein on a dry matter basis, or between 7 to 11 wt % plant protein on a dry matter basis, or between 8 to 10 wt % plant protein on a dry matter basis, or about 9 wt % plant protein on a dry matter basis.

In some embodiments, the egg analogue product comprises between 8 to 14 wt % plant protein on a dry matter basis, or between 9 to 13 wt % plant protein on a dry matter basis, or between 10 to 12 wt % plant protein on a dry matter basis, or about 11 wt % plant protein on a dry matter basis.

In some embodiments, the egg analogue product comprises between 10 to 16 wt % plant protein on a dry matter basis, or between 11 to 15 wt % plant protein on a dry matter basis, or between 12 to 14 wt % plant protein on a dry matter basis, or about 13 wt % plant protein on a dry matter basis.

In some embodiments, the egg analogue product comprises between 10 to 16 wt % soy protein on a dry matter basis, or between 11 to 15 wt % soy protein on a dry matter basis, or between 12 to 14 wt % soy protein on a dry matter basis, or about 13 wt % plant protein on a dry matter basis.

In some embodiments, the egg analogue product comprises between 10 to 16 wt % soy protein on a dry matter basis, or between 11 to 15 wt % soy protein on a dry matter basis, or between 12 to 14 wt % soy protein on a dry matter basis, or about 13 wt % plant protein on a dry matter basis, and the basic salt is potassium carbonate.

In some embodiments, the egg analogue product comprises between 10 to 16 wt % canola protein on a dry matter basis, or between 11 to 15 wt % canola protein on a dry matter basis, or between 12 to 14 wt % canola protein on a dry matter basis, or about 13 wt % canola protein on a dry matter basis, and the basic salt is potassium carbonate.

In some embodiments, the egg analogue product comprises between 10 to 16 wt % canola protein on a dry matter basis, or between 11 to 15 wt % canola protein on a dry matter basis, or between 12 to 14 wt % canola protein on a dry matter basis, or about 13 wt % canola protein on a dry matter basis, and the basic salt is potassium hydroxide.

In some embodiments, the plant protein source is soy protein and canola protein. The soy protein and canola protein may be present in the product in a ratio of about 1:1. In some embodiments, the egg analogue product comprises between 8 to 14 wt % soy protein and canola protein in combination on a dry matter basis, or between 9 to 13 wt % soy protein and canola protein in combination on a dry matter basis, or between 10 to 12 wt % soy protein and canola protein in combination on a dry matter basis, or about 11 wt % soy protein and canola protein in combination on a dry matter basis, and the basic salt is potassium carbonate.

In some embodiments, the plant protein source is in the form of a flour and/or protein concentrate. Preferably, the plant protein source is in the form of a flour and protein concentrate. Preferably, the flour and the protein concentrate are from the same plant source.

In some embodiments, the ratio of plant protein contributed by the flour to the plant protein contributed by the protein concentrate is between 1 and 5, for example about 2.5.

In some embodiments, the ratio of the plant protein to the base from the basic salt is between 2 and 20, preferably between 2 and 5.

In some embodiments, the basic salt is selected from potassium carbonate, potassium hydroxide, sodium carbonate, sodium hydroxide, ammonium carbonate, ammonium hydroxide. In some embodiments, the basic salt is potassium carbonate. In some embodiments, the basic salt is potassium hydroxide. In some embodiments, the basic salt is sodium carbonate. In some embodiments, the basic salt is sodium hydroxide. In some embodiments, the basic salt is ammonium carbonate. In some embodiments, the basic salt is ammonium hydroxide.

In some embodiments, the basic salt liberates a gas upon acidification and/or heating.

In some embodiments, said product comprises up to 30 millimoles basic salt per 100 g egg analogue product dry matter.

In some embodiments, said product comprises between 0.01 to 3 millimoles basic salt per 100 g egg analogue product dry matter. In some embodiments, said product comprises about 0.23 millimoles basic salt, for example potassium hydroxide, per 100 g egg analogue product dry matter. In some embodiments, said product comprises about 1.7 millimoles basic salt, for example potassium carbonate, per 100 g egg analogue product dry matter.

In some embodiments, the basic salt is a carbonate salt, and said product comprises between 3 and 30 millimoles carbonate per 100 g egg analogue product dry matter.

In some embodiments, the basic salt is a hydroxide salt, and said egg analogue product comprises between 3 and 30 millimoles hydroxide per 100 g egg analogue product dry matter.

The invention further relates to an egg analogue product according to the invention, wherein the product is in powder format.

In some embodiments, the product is devoid of animal products.

The invention further relates to an egg analogue product according to the invention for use as a whole or partial egg replacement in a cooked in pan egg application, in batter, in sauces, or in baked products.

The invention further relates to an egg analogue product according to the invention for use as a binder.

The invention further relates to a food product comprising the egg analogue product according to the invention, wherein said food product further comprises chicken egg.

The invention further relates to a method of making an egg analogue product, said method comprising mixing a plant protein source and a basic salt, wherein the basic salt has a pKa in water above 7 and an equilibrium solubility in water above 0.1 g per 100 g at 25° C. at pH 7.

The invention further relates to use of a plant protein source and a basic salt to extend an egg product, wherein the basic salt has a pKa in water above 7 and an equilibrium solubility in water above 0.1 g per 100 g at 25° C. at pH 7.

The invention further relates to use of a basic salt to improve the fracturability of a reconstituted egg product comprising plant protein, wherein the basic salt has a pKa in water above 7 and an equilibrium solubility in water above 0.1 g per 100 g at 25° C. at pH 7.

### DETAILED DESCRIPTION OF INVENTION

### Egg Analogue Product

The egg analogue product comprises a plant protein source and basic salt. Preferably, the egg analogue product is in a powder form.

The egg analogue product may comprise over 80%, or over 90%, or over 95% of a combination of plant protein source and basic salt, or consists entirely of a combination of plant protein source and basic salt.

The egg analogue product may also comprise one or more of the following ingredients: oil, for example sunflower oil; iron source, for example iron pyrophosphate.

The egg analogue product may comprise over 80%, or over 90%, or over 95% of a combination of plant protein source, basic salt, sunflower oil, and iron source or consists entirely of a combination of plant protein source, basic salt, sunflower oil, and iron source.

The egg analogue product may comprise between 60 to 70 wt % flour, for example soybean flour, between 15 to 25 wt % protein concentrate, for example soybean protein concentrate, between 0.5 to 3.5 wt % basic salt, for example potassium carbonate, and between 5 to 10 wt % oil, for example sunflower oil.

The egg analogue product may further comprise a polysaccharide.

Table 2 comprises egg analogue product compositions. The egg analogue product may have substantially the same composition as any one of V11, V17, and V45. Preferably, the egg analogue product has substantially the same composition as any one of V5 and V37.

### Plant Protein Source

Flour can be used as a plant protein source. The preferred flour is soy flour. The soy flour typically has a protein content of between 40 to 55 wt %, preferably about 47 wt % in the soy flour.

Plant protein concentrate can be used as a protein source. The preferred protein concentrate is soy protein concentrate. The soy protein concentrate typically has a protein content of between 60 to 80 wt %, preferably about 70 wt % in the plant protein concentrate.

A combination of flour and plant protein concentrate can be used as a plant protein source.

Ratio of Plant Protein to Base from Basic Salt

When the basic salt has a pKa greater than 7, then the preferred ratio is 2-5.

When the basic salt is potassium carbonate, sodium carbonate, ammonium carbonate, calcium carbonate, or magnesium carbonate, then the preferred ratio of grams of plant protein to millimoles of base from the basic salt is between 2.2 to 13.8 in the egg analogue product.

When the basic salt is potassium hydroxide, then the preferred ratio of grams of plant protein to millimoles of base from the basic salt is between 2.0 to 11.8 in the egg analogue product.

When the basic salt is calcium hydroxide, then the preferred ratio of grams of plant protein to millimoles of base from the basic salt is between 2.1 to 15.5 in the egg analogue product.

### Ratio of Protein Contributed by Flour and Concentrate

The preferred ratio of protein contributed by flour to that contributed by protein concentrate is between 2 to 3, preferably about 2.5 in the egg analogue product.

### Basic Salt Concentration

When the basic salt is potassium carbonate, sodium carbonate, ammonium carbonate, calcium carbonate, or magnesium carbonate, then the preferred basic salt concentration is between 3.6 to 21.7 millimoles per 100 g in the egg analogue product.

When the basic salt is potassium hydroxide, then the preferred basic salt concentration is between 4.2 to 25 millimoles per 100 g in the egg analogue product.

When the basic salt is calcium hydroxide, then the preferred basic salt concentration is between 1.6 to 11.5 millimoles per 100 g in the egg analogue product.

### Basic Salt Properties

The basic salt in the egg analogue product may have the following properties:
(i) an equilibrium solubility in water of greater than 0.1 g per 100 g and a pKa of about 10.33; or
(ii) an equilibrium solubility in water of greater than 0.1 g per 100 g and a pKa of about 14; or
(iii) an equilibrium solubility in water of less than 0.1 g per 100 g and a pKa of about 10.33.

### Food Product

The egg analogue product can be added to beaten egg, for example a beaten chicken egg. The resulting food product may comprise an approximate 1:1 wt % ratio of egg analogue product and beaten chicken egg.

Typically, between 30 to 45% of the protein content of the food product is contributed by the chicken egg. Typically, the food product is in liquid form.

### Definitions

When a composition is described herein in terms of wt. %, this means a mixture of the ingredients on a moisture free basis, unless indicated otherwise.

As used herein, the term “about” or “substantially” is understood to refer to numbers in a range of numerals, for example the range of −30% to +30% of the referenced number, or −20% to +20% of the referenced number, or −10% to +10% of the referenced number, or −5% to +5% of the referenced number, or −1% to +1% of the referenced number. All numerical ranges herein should be understood to include all integers, whole or fractions, within the range.

As used herein, the term “equilibrium solubility” means the concentration limit, at thermodynamic equilibrium, that a solute can dissolve into a saturated solution when excess solid is present. Equilibrium can be defined as sufficiently converged when it no longer changes significantly during a certain time frame (as described in Current Official General Informational Chapter <1236> Solubility Measurements).

As used herein, the term “analogue” is considered to be an edible substitute of a substance in regard to one or more of its major characteristics. An “egg analogue product” as used herein is a substitute of egg in the major characteristics of purpose and usage. Preferably, the egg analogue product is an analogue of chicken egg.

As used herein, the term “vegan” refers to an edible composition which is entirely devoid of animal products, or animal derived products, for example eggs, milk, honey, fish, and meat.

As used herein, the term “vegetarian” relates to an edible composition which is entirely devoid of meat, poultry, game, fish, shellfish or by-products of animal slaughter. A vegetarian composition may include eggs from an animal, for example chicken egg.

As used herein, the term polysaccharide relates to a type of carbohydrate. A polysaccharide is a polymer comprising chains of monosaccharides that are joined by glycosidic linkages. Polysaccharides are also known as glycans. By convention, a polysaccharide consists of more than ten monosaccharide units. Polysaccharides may be linear or branched. They may consist of a single type of simple sugar (homopolysaccharides) or two or more sugars (heteropolysaccharides). The main functions of polysaccharides are structural support, energy storage, and cellular communication. Examples of polysaccharides include carrageenan, cellulose, hemicellulose, chitin, chitosan, glycogen, starch, dextrin (starch gum), hyaluronic acid, polysdextrose, inulin, beta-glucan, pectin, psyllium husk mucilage, beta-mannan, carob, fenugreek, guar gum tara gum, konjac gum or glucomannan, gum acacia (arabic), karaya, tragacanth, arabinoxylan, gellan, xanthan, agar, alginate, methylcellulose, carboxymethylcelulose, hydroxypropyl methylcellulose, microfibrilated cellulose, microcrystalline cellulose.

As used herein, a “protein concentrate” comprises between 60 to 80 wt. % protein, or about 74 wt. % protein.

As used herein, a “protein isolate” comprises more than 80 wt. % protein, or about 84 wt. % protein.

Those skilled in the art will understand that they can freely combine all features of the present invention disclosed herein. In particular, features described for the compositions of the present invention may be combined with the method or uses of the present invention and vice versa. Further, features described for different embodiments of the present invention may be combined. Where known equivalents exist to specific features, such equivalents are incorporated as if specifically referred to in this specification.

Further advantages and features of the present invention are apparent from the figures and non-limiting examples.

### EXAMPLES

### Example 1

### Egg Analogue Compositions and Recipes

A total of fifty-four egg analogue products in powder format were produced. Their ingredients were a mix of soy flour (at least 47 wt % protein content) and soy concentrate (at least 70 wt % protein content) as plant protein source and a salt. Approximately 42 g of egg analogue product were further reconstituted with water and 45 g of beaten chicken egg in order to extend it.

The egg analogue products were produced by premixing the plant protein sources and salts according to composition target reported in Table 2. The powder mix was reconstituted together with water and chicken egg by magnetic stirring at room temperature. In total, the stirring lasted less than 10 min.

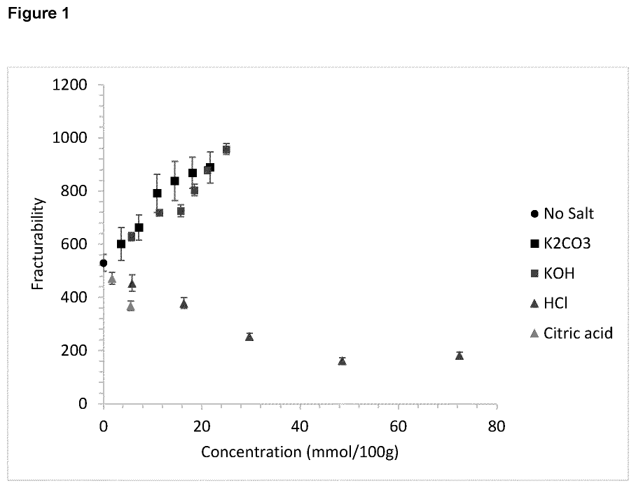

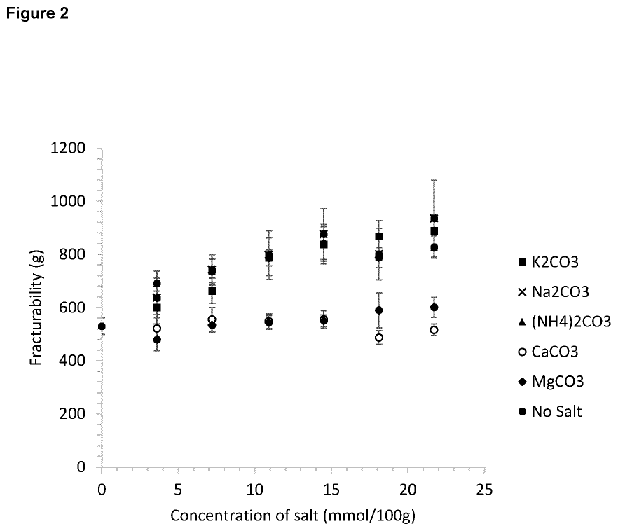

The reconstituted products were heated in a water bath to form gels that were subsequently analyzed to determine their texture properties. The products were drawn up into pre-lubricated (vegetable oil) sealed plastic syringes and heated at 97° C. for 30 min in a water bath. Afterwards the gels were stored overnight at 25° C. and then cut into cylindrical pieces (2 cm×2 cm). Each cylindrical piece was submitted to a double compression test performed using a texture analyzer (TA.HDplusC from Stable Micro Systems, Vienna Court, Lammas Road, Godalming, Surrey GU7 1YL, United Kingdom; www.stablemicrosystems.com) equipped with a 5 kg load cell. A double compression test was applied to each piece of gel placed in between a compression plate and probe (P75, 750 mm). Compressions were performed at 75% of the initial height of the gel piece at a compression speed of 1 mm/s. Measurements were performed six times for each gel. Texture values for each texture attribute defined in Table 1 were extracted. Their averages and standard deviation are reported in FIGS. 1 and 2.

TABLE 1
texture attributes and definition

| Texture attribute | Brief definition |
|---|---|
| Hardness | Maximum peak force during the first compression cycle (first |
| | bite/firmness) |
| Fracturability (brittleness) | The force at the first significant break |
| Adhesiveness | Negative force area for the first bite and represents the work |
| | required to overcome the attractive forces between the surface |
| | of a food and the surface of other materials with which the food |
| | comes into contact, |
| Cohesiveness | Ratio of the positive force area during the second compression |
| | to that of the first compression |
| Springiness (Elasticity) | Height that the food recovers during the time that elapses |
| | between the end of the first bite and the start of the second bite |
| Gumminess (semi solid) | Hardness × cohesiveness |

K₂CO₃, Na₂CO₃ and (NH₄)₂CO₃ have a pKa of 10.33 and an equilibrium solubility in water above 0.1 g per 100 g at 25° C. and at pH 7. MgCO₃ and CaCO₃ have a pKa of 10.33 and an equilibrium solubility in water below 0.1 g per 100 g at 25° C. and at pH 7. KOH and Ca(OH)₂ have a pKa of 14 and an equilibrium solubility in water above 0.1 g per 100 g at 25° C. and at pH 7. HCl has a pKa below 0 and an equilibrium solubility in water above 0.1 g per 100 g at 25° C. and at pH 7. Citric acid has a pKa of 3.08 and an equilibrium solubility in water above 0.1 g per 100 g at 25° C. and at pH 7.

TABLE 2
composition of the egg analogue products
and the pH in the reconstituted products.

| | Composition of powder mix | | | | |
|---|---|---|---|---|---|
| | Ratio of | Ratio of | | Salt | Recon- |
| | protein/ | protein | | concen- | stituted |
| | base | flour/ | Salt | tration | product |
| | g/mmol | concentrate | source | mmol/100 g | pH |
| V1 | X | 2.5 | X | 0 | 6.6 |
| V2 | 13.8 | 2.5 | K₂CO₃ | 3.6 | 6.9 |
| V3 | 6.9 | 2.5 | K₂CO₃ | 7.2 | 7.2 |
| V4 | 4.5 | 2.5 | K₂CO₃ | 10.9 | 7.7 |
| V5 | 3.4 | 2.5 | K₂CO₃ | 14.5 | 8.0 |
| V6 | 2.7 | 2.5 | K₂CO₃ | 18.1 | 8.5 |
| V7 | 2.2 | 2.5 | K₂CO₃ | 21.7 | 8.8 |
| V8 | 13.8 | 2.5 | Na₂CO₃ | 3.6 | 6.9 |
| V9 | 6.9 | 2.5 | Na₂CO₃ | 7.2 | 7.2 |
| V10 | 4.5 | 2.5 | Na₂CO₃ | 10.9 | 7.6 |
| V11 | 3.4 | 2.5 | Na₂CO₃ | 14.5 | 8.1 |
| V12 | 2.7 | 2.5 | Na₂CO₃ | 18.1 | 8.5 |
| V13 | 2.2 | 2.5 | Na₂CO₃ | 21.7 | 8.8 |
| V14 | 13.8 | 2.5 | (NH₄)₂CO₃ | 3.6 | 6.9 |
| V15 | 6.9 | 2.5 | (NH₄)₂CO₃ | 7.2 | 7.3 |
| V16 | 4.5 | 2.5 | (NH₄)₂CO₃ | 10.9 | 7.7 |
| V17 | 3.4 | 2.5 | (NH₄)₂CO₃ | 14.5 | 7.9 |
| V18 | 2.7 | 2.5 | (NH₄)₂CO₃ | 18.1 | 7.8 |
| V19 | 2.2 | 2.5 | (NH₄)₂CO₃ | 21.7 | 8.2 |
| V20 | 13.8 | 2.5 | CaCO₃ | 3.6 | 6.7 |
| V21 | 6.9 | 2.5 | CaCO₃ | 7.2 | 6.7 |
| V22 | 4.5 | 2.5 | CaCO₃ | 10.9 | 6.7 |
| V23 | 3.4 | 2.5 | CaCO₃ | 14.5 | 6.7 |
| V24 | 2.7 | 2.5 | CaCO₃ | 18.1 | 6.6 |
| V25 | 2.2 | 2.5 | CaCO₃ | 21.7 | 6.7 |
| V26 | 13.8 | 2.5 | CaCO₃ | 3.6 | 6.6 |
| V27 | 6.9 | 2.5 | CaCO₃ | 7.2 | 6.6 |
| V28 | 4.5 | 2.5 | CaCO₃ | 10.9 | 6.6 |
| V29 | 3.4 | 2.5 | CaCO₃ | 14.5 | 6.6 |
| V30 | 2.7 | 2.5 | CaCO₃ | 18.1 | 6.6 |
| V31 | 2.3 | 2.5 | CaCO₃ | 21.7 | 6.6 |
| V32 | 11.8 | 2.5 | KOH | 4.2 | 6.8 |
| V33 | 8.7 | 2.5 | KOH | 5.7 | 6.9 |
| V34 | 5.3 | 2.5 | KOH | 9.3 | 7.1 |
| V35 | 4.3 | 2.5 | KOH | 11.4 | 7.3 |
| V36 | 3.1 | 2.5 | KOH | 15.7 | 7.6 |
| V37 | 2.7 | 2.5 | KOH | 18.5 | 7.9 |
| V38 | 2.3 | 2.5 | KOH | 21.2 | 8.4 |
| V39 | 2.0 | 2.5 | KOH | 25.0 | 8.8 |
| V40 | 15.5 | 2.5 | Ca(OH)₂ | 1.6 | 6.7 |
| V41 | 6.0 | 2.5 | Ca(OH)₂ | 4.1 | 6.9 |
| V42 | 3.8 | 2.5 | Ca(OH)₂ | 6.5 | 7.2 |
| V43 | 3.8 | 2.5 | Ca(OH)₂ | 6.6 | 7.3 |
| V44 | 2.8 | 2.5 | Ca(OH)₂ | 8.9 | 7.7 |
| V45 | 2.8 | 2.5 | Ca(OH)₂ | 9.0 | 8.0 |
| V46 | 2.2 | 2.5 | Ca(OH)₂ | 11.3 | 8.5 |
| V47 | 2.1 | 2.5 | Ca(OH)₂ | 11.5 | 8.7 |
| V48 | 0.7 | 2.5 | HCl | 72.4 | 4.3 |
| V49 | 1.0 | 2.5 | HCl | 48.5 | 4.7 |
| V50 | 1.7 | 2.5 | HCl | 29.7 | 5.3 |
| V51 | 3.0 | 2.5 | HCl | 16.4 | 5.8 |
| V52 | 8.5 | 2.5 | HCl | 5.8 | 6.3 |
| V53 | 8.9 | 2.5 | Citric acid | 5.5 | 5.8 |
| V54 | 28.7 | 2.5 | Citric acid | 1.7 | 6.3 |

Egg analogue products V11, V17, V45 performed well. The best performing products were V5 and V37.

### Example 2

### Impact of the pKa Values of Salts on the Fracturability

FIG. 1 shows the impact of salts with different pKa values at various concentration on the fracturability of gels prepared with egg analogue product. The gels were produced and analyzed by texture analyzer according to the respective methods described in example 1. In FIG. 1, errors bars represent the standard deviation of the fracturability for each salt at a certain concentration. The results show that an increasing concentration of salts with a pKa value above 7 i.e., K₂CO₃ and KOH, causes an increase in gel fracturability. The opposite effect is observed for salts with a pKa value below 7 i.e., citric acid and HCl. For Ca(OH)₂, a similar behaviour as for KOH was observed.

### Example 3

### Impact of the Equilibrium Solubility of Salts on the Fracturability

FIG. 2 shows the impact of salts with different equilibrium solubility at various concentrations on the fracturability of gels prepared with egg analogue product. The gels were produced and analyzed by texture analyzer according to the respective methods describe in example 1. In FIG. 2, errors bars represent the standard deviation of the fracturability for each salt at a certain concentration. The results show that only the salts with an equilibrium solubility in water above 0.1 g per 100 g at 25° C. i.e., K₂CO₃, Na₂CO₃ and (NH₄)₂CO₃, increase the gel fracturability.

### Example 4

### Cake Recipe Made Using Egg Analogue Product

A cake was produced by partially replacing eggs in the recipe with an egg analogue product V5, produced according to the method described in example 1. 13 g of powder product were reconstituted together with 42.8 g of water and 34.2 g of freshly beaten chicken egg. This mixture was used to replace 2 eggs in the cake recipe described in Table 3.

TABLE 3
ingredients list for cake recipe

| Ingredient | Quantity | |
|---|---|---|
| Butter | 113 | g |
| Sugar | 150 | g |
| Freshly beaten egg or | 90 g (equivalent of | |
| egg replacement mixture | 2 small eggs) | |
| Flour | 115 | g |
| Baking powder | 6 | g |
| Milk | 120 | g |

The sugar and butter were mixed for 2 min and the egg replacement mixture was then added into the sugar and butter and further mixed for 1 min. The flour and baking powder were added and mixed for approximately 1 min and finally the milk was introduced and mixed to obtain a homogeneous mixture.

The homogeneous mixture was then poured into a cake tin and cooked for 30 min at 180° C.

The final appearance, taste and texture of the cake produced with the egg analog product was similar to a cake prepared with chicken egg only.

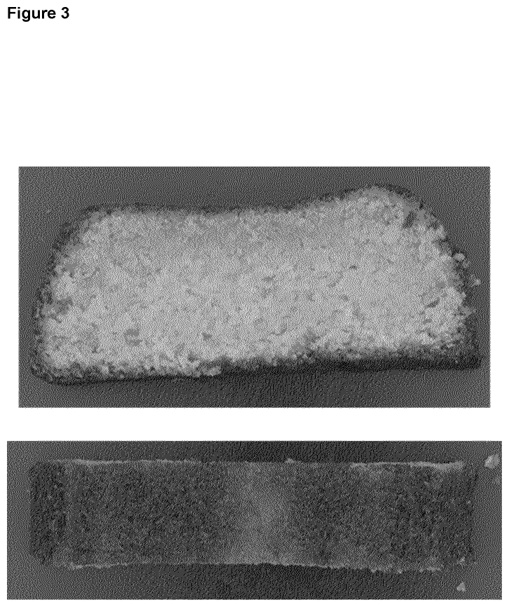

FIG. 3 shows a picture of a slice (front and top views) of the cake produced with the egg analogue product.

### Example 5

### Fracturability of Heat Set Gels

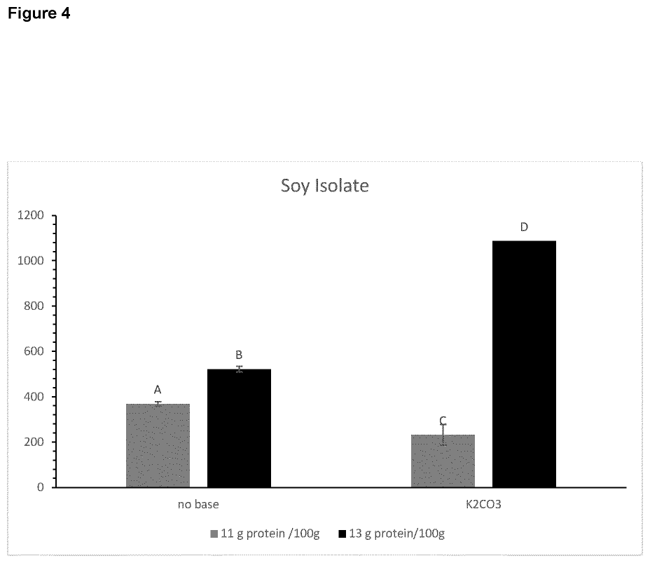

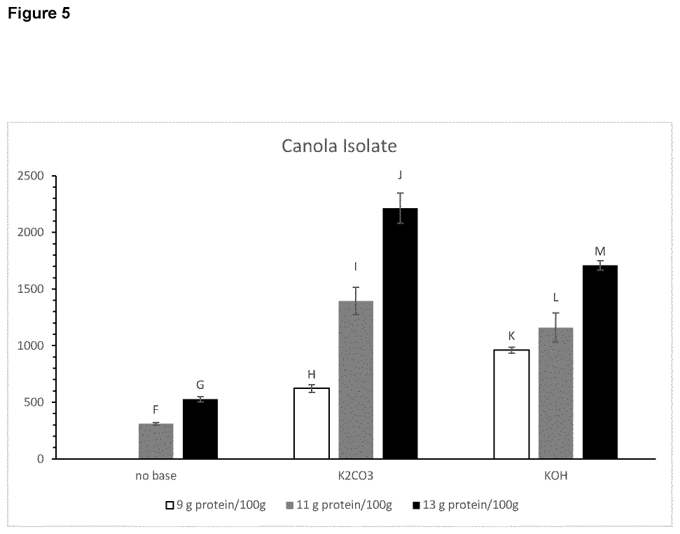

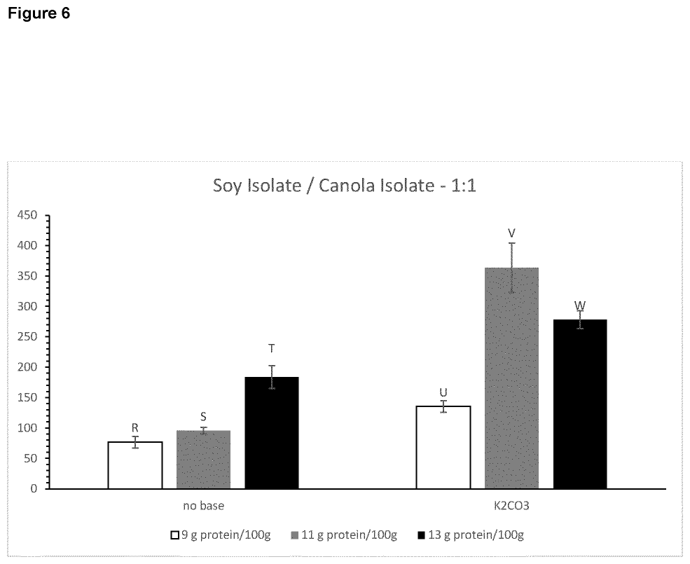

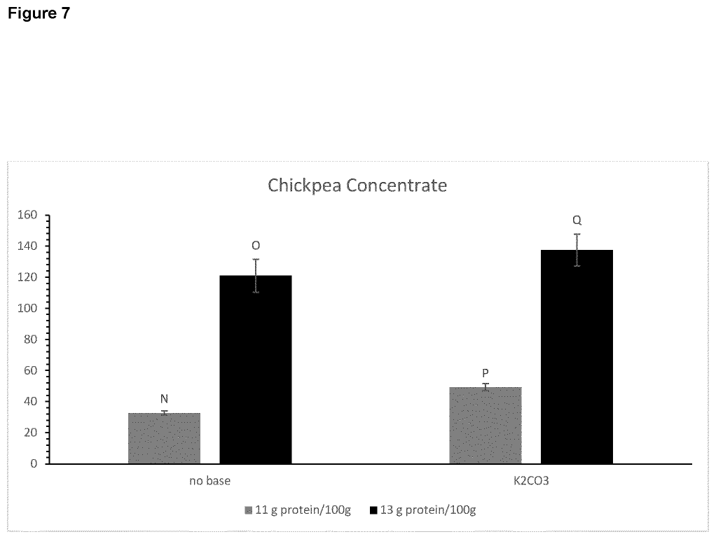

23 protein suspensions were produced. The plant protein ingredients were reconstituted in water, together with a basic salt when indicated (Table 4), using a high shear mixing equipment (Silverson L5M-A, Sylverson, United States). The reconstitution speed was set to 2 000 rpm for 2 min. The suspensions were submitted to heat gelation and texture analysis through a double compression test as indicated in Example 1. The fracturability of the heat set gels were extracted and reported in FIGS. 4 to 7.

TABLE 4
composition of the protein suspensions and their pH

| | | | Protein | | Basic salt | |
|---|---|---|---|---|---|---|
| | Ratio | | concen- | | concen- | |
| | prot/base | Protein | tration | Basic salt | tration | |
| | g/mmol | source | g/100 g | source | mmol/100 g | pH |
| A | NA | soy | 11 | no base | 0 | 7.15 |
| B | NA | isolate | 13 | no base | 0 | 7.09 |
| C | 6.5 | | 11 | K₂CO₃ | 1.7 | 8.93 |
| D | 7.6 | | 13 | K₂CO₃ | 1.7 | 8.93 |
| E | NA | canola | 9 | no base | 0 | 6.09 |
| F | NA | isolate | 11 | no base | 0 | 6.08 |
| G | NA | | 13 | no base | 0 | 6.07 |
| H | 5.3 | | 9 | K₂CO₃ | 1.7 | 7.98 |
| I | 6.5 | | 11 | K₂CO₃ | 1.7 | 7.67 |
| J | 7.6 | | 13 | K₂CO₃ | 1.7 | 7.58 |
| K | 36.6 | | 8.41 | KOH | 0.23 | 8.24 |
| L | 44.7 | | 10.28 | KOH | 0.23 | 7.91 |
| M | 52.8 | | 12.15 | KOH | 0.23 | 7.4 |
| N | NA | chickpea | 11 | no base | 0 | 7.77 |
| O | NA | concentrate | 13 | no base | 0 | 7.75 |
| P | 6.5 | | 11 | K₂CO₃ | 1.7 | 8.95 |
| Q | 7.6 | | 13 | K₂CO₃ | 1.7 | 8.76 |
| R | NA | Soy + | 9 | no base | 0 | 6.84 |
| S | NA | canola | 11 | no base | 0 | 6.8 |
| T | NA | isolates | 13 | no base | 0 | 6.78 |
| U | 5.29 | 50/50 | 9 | K₂CO₃ | 1.7 | 8.69 |
| V | 6.47 | | 11 | K₂CO₃ | 1.7 | 8.25 |
| W | 7.65 | | 13 | K₂CO₃ | 1.7 | 8.05 |

### Example 6

Effect of Salt with pKa Value Above 7 on Fracturability

FIGS. 4 to 7 show the impact of addition of K₂CO₃ and KOH on the fracturability of plant protein suspensions containing between 9 and 13 g/100 g of protein and prepared from soy isolate, canola isolate, a mixture of the two and chickpea concentrate. The basic salts were added at concentrations of 1.7 and 0.23 mmol/100 g of suspensions for K₂CO₃ and KOH respectively.

Errors bars represent the standard deviation for the fracturability measurements of sixplicate of gel induced and measured as described in example 1. The results show that the addition of salts with a pKa value above 7 i.e., K₂CO₃ and KOH, causes an increase in gel fracturability.

### Example 7

### Baked Product: Cheese Soufflé

A cheese souffle was produced by partially replacing eggs in the recipe with an egg analogue product V5, produced according to the method described in example 1. 120 g of butter was melted in a sauce pan over medium-low temperature. 80 g of flour was whisked into the melted butter until smooth and homogenous. The heat and stir were maintained until the butter-flour mix turned a light, golden color to form a roux. 8 dl of milk was incorporated into the roux to form the base mix that was further stirred and cooked over medium-low heat until its consistency thickened, and the flour grittiness is no longer perceived. The base was transferred in a large bowl and allowed to cool at room temperature. 52 g of powder product were reconstituted together with 171.2 g of water. 3 medium size eggs were separated into yolk (approximately 45 g) and white (approximately 90 g). The reconstituted product and egg yolks were mixed together with 200 g of grated gruyere and incorporated in the cooled base. The egg whites were first whisked up to firm foam prior their incorporation into the mix. The cheese souffle mix was transferred into a tin a cooked for approximately 30 min at 200° C.

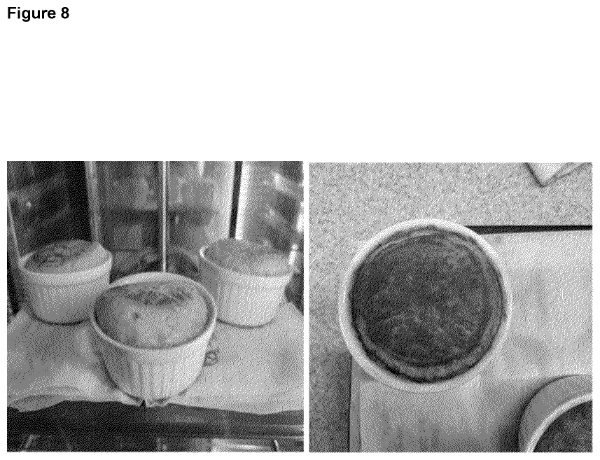

The final appearance, taste, and texture of the cheese souffle produced with the egg analogue product was similar to a cheese soufflé prepared with chicken egg only. FIG. 8 shows a picture of the cheese soufflé produced with the egg analogue product.

### Example 8

### Sauce: Hollandaise Sauce

A sauce hollandaise was produced by partially replacing eggs in the recipe with an egg analogue product V5, produced according to the method described in example 1.

52 g of powder product were reconstituted together with 71.2 g of water and 45 g of freshly beaten chicken egg yolk. This mixture was used to replace 8 eggs in the hollandaise sauce recipe. The juice of 2 lemons was incorporated in the egg replacement mix and cooked over low heat and constant stirring until 70° C. were reached. 500 g of melted butter was vigorously incorporated into the 70° C. egg replacement-lemon juice mixture to form a thick and homogeneous emulsion. The sauce was seasoned with salt and pepper and served immediately.

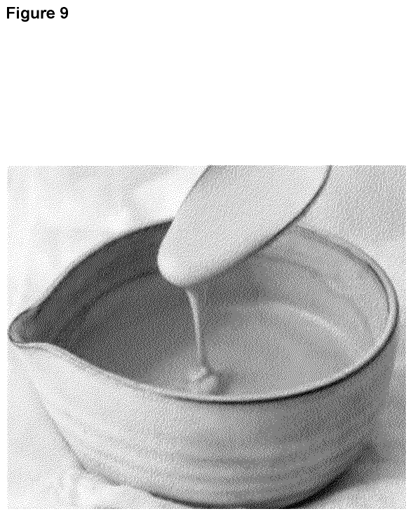

The final appearance, taste, and texture of the hollandaise sauce produced with the egg analogue product was similar to a hollandaise sauce prepared with chicken eggs only. FIG. 9 shows a picture of the hollandaise sauce produced with the egg analogue product.

### Example 9

### Batter

Batter was produced by partially replacing eggs in the recipe with an egg analogue product V5, produced according to the method described in example 1. 52 g of powder product were reconstituted together with 150 mL of blond beer and 135 g of freshly beaten chicken egg to produce the batter. 1 L of sunflower oil was heated to 180° C. over medium heat in a large saucepan and used for frying. Pieces of vegetables, such as green beans or cauliflower, were dipped into the batter containing the egg replacement product and deep fried for 3-4 min until crisp and golden.

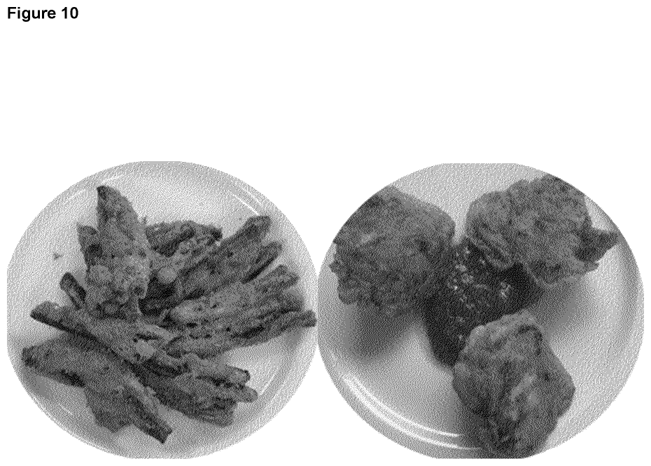

The final appearance, taste, and texture of the batter produced with the egg analogue product was similar to a batter prepared with chicken eggs only. FIG. 10 shows a picture of the green beans (on the left) and cauliflower (on the right) fried in the batter produced with the egg analogue product.

### Example 10

### Cooked in Pan: Tortilla De Papas

A tortilla de papas was produced by partially replacing eggs in the recipe with an egg analogue product V5, produced according to the method described in example 1. Approximately 600 g of fresh potatoes were peeled, washed, and cut into approximately 0.5 cm width slices. The sliced potatoes were cooked for 15 min in a large frying pan at medium low heat, containing 50 g of pre heated olive oil. 200 g of sliced onions were added in the pan and mixed in the sliced potatoes to further cook for 5 min. The excess of oil was removed using a spoon and the cooked potatoes and onions were set at the bottom of the pan. 4 g of garlic puree was dispersed on the top. 52 g of powder product were reconstituted together with 171.2 g of water and 136.8 g of freshly beaten chicken egg. This mixture was used to replace 8 eggs in the tortilla de papas and was poured over the sliced potatoes, onions and garlic mix. The tortilla was cooked for 6-8 min on both side over medium-low heat until providing a well cooked and rubbery texture.

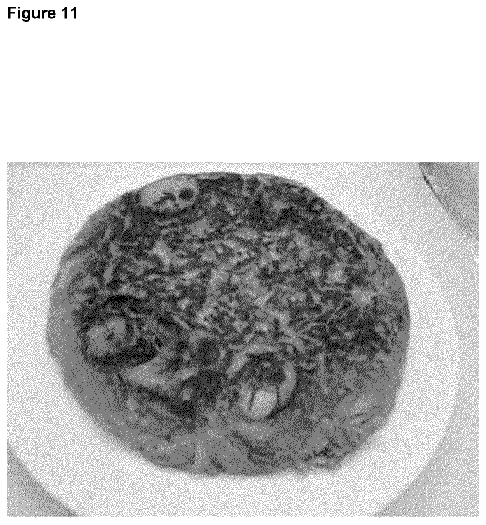

The final appearance, taste, and texture of the tortilla de papas produced with the egg analogue product was similar to a tortilla de papas prepared with chicken egg only. FIG. 11 shows a picture of the tortilla de papas produced with the egg analogue product.

### Example 11

### Flan: Crema Volteada

A crema volteada was produced by partially replacing eggs in the recipe with an egg analogue product V5, produced according to the method described in example 1. 200 g of sugar and 2 dl of water were mixed and cooked in a pan to produce liquid caramel and further transferred into a cake tin. 52 g of powder product were reconstituted together with 171.2 g of water and 136.8 g of freshly beaten chicken egg. This mixture was used to replace 8 eggs in the flan recipe described in Table 3.

TABLE 5
ingredients list for cake recipe

| Ingredient | Quantity | |
|---|---|---|
| Sweetened Condensed milk | 800 | g |
| Evaporated milk | 400 | g |
| Cream 35% | 400 | g |
| Vanilla extract | 15 | mL |

| | |
|---|---|
| Freshly beaten egg or | 360 g (equivalent of |
| egg replacement mixture | 8 small eggs) |

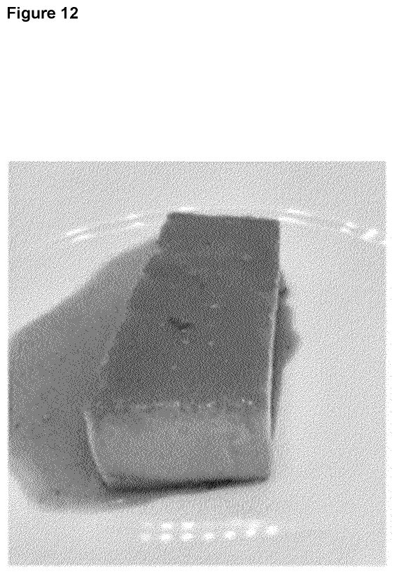

The milks, cream and vanilla extract were mixed together with the egg replacement to obtain a homogeneous mixture. The homogeneous mixture was then poured into the cake tin containing the caramel and cooked in a water bath in the oven for 40 min at 110° C. followed by 30 min at 80° C. The cooked crema volteada was then further cooled down in the fridge to set for 4 hours. The final appearance, taste and texture of the crema volteada produced with the egg analogue product was similar to a crema volteada prepared with chicken egg only. FIG. 12 shows a picture of the crema volteada produced with the egg analogue product.

1. An egg analogue product, said product comprising a plant protein source and a basic salt, wherein the salt has a pKa in water above 7 and an equilibrium solubility in water above 0.1 g per 100 g at 25° C. at pH 7.

2. An egg analogue product according to claim 1, wherein the plant protein source is derived from soybean or canola.

3. An egg analogue product according to claim 1, wherein the plant protein source is in the form of a protein concentrate.

4. An egg analogue product according to claim 1, wherein the plant protein source is in the form of a flour and a protein concentrate.

5. An egg analogue product according to claim 1, wherein the ratio of plant protein contributed by the flour to the plant protein contributed by the protein concentrate is between 1 and 5.

6. An egg analogue product according to claim 1, wherein the ratio of the plant protein to the base from the basic salt is between 2 and 20.

7. An egg analogue product according to claim 1, wherein the salt is selected from the group consisting of potassium carbonate, potassium hydroxide, sodium carbonate, sodium hydroxide, ammonium carbonate, and ammonium hydroxide.

8. An egg analogue product according to claim 1, wherein the basic salt liberates a gas upon acidification and/or heating.

9. An egg analogue product according to claim 1, wherein said product comprising up to 30 millimoles basic salt per 100 g egg analogue product dry matter.

10. An egg analogue product according to claim 1, wherein the basic salt is a carbonate salt, and said product comprises between 3 and 30 millimoles carbonate per 100 g egg analogue product dry matter.

11. An egg analogue product according to claim 1, wherein the product comprises between 15 to 25 wt % soybean flour, between 0.5 to 3.5 wt % potassium carbonate, and between 5 to 10 wt % sunflower oil.

12. An egg analogue product according to claim 1, wherein the basic salt is a hydroxide salt, and said egg analogue product comprises between 3 and 30 millimoles hydroxide per 100 g egg analogue product dry matter.

13. An egg analogue product according to claim 1, wherein the product is in powder format.

14. (canceled)

15. A food product comprising a plant protein source and a basic salt, wherein the salt has a pKa in water above 7 and an equilibrium solubility in water above 0.1 g per 100 g at 25° C. at pH 7, wherein said food product further comprises chicken egg.

16. A method of making an egg analogue product, said method comprising mixing a plant protein source and a basic salt, wherein the basic salt has a pKa in water above 7 and an equilibrium solubility in water above 0.1 g per 100 g at 25° C. at pH 7.

17. (canceled)
